(19) United States
(12) Patent Application Publication
(10) Pub. No.: US 2011/0029354 A1
(43) Pub. Date: Feb. 3, 2011

(54) METHOD AND SYSTEM FOR PROVIDING INFORMATION ABOUT BRAND PROFILING OF CELEBRITIES BY USING ONLINE PROCESSING SYSTEM

(76) Inventor: Aidan Joungil CHO, Austin, TX (US)

Correspondence Address: Jason Y. Pahng and Associates, LLC, 12178 Bridgend Run, Fairfax, VA, 22030, US

(21) Appl. No.: 12/846,849

(22) Filed: Jul. 30, 2010

(30) Foreign Application Priority Data
Jul. 30, 2009 (KR) 10-2009-0069964

(51) Int. Cl. G06F 17/30

(52) U.S. Cl. 705/10

(57) ABSTRACT

A method of online providing brand profiling information of a celebrity, the method including the operations of having a brand selected for each product category by a plurality of connectors who connect to a website, and having a person selected, wherein the person is approved to match well with the brand; increasing a number indicating how many times the person is selected whenever the person is selected by the plurality of connectors, and when the number exceeds a predetermined reference, changing data indicating whether the person needs to be requested to open his/her brand profiling into an open status, and extracting the person the data of whom is changed to the open status; requesting the person for performing brand profiling; having the person select a brand for the each product category; and opening the brand selected by the person.

### CROSS-REFERENCE TO RELATED PATENT APPLICATION

This application claims the benefit of Korean Patent Application No. 10-2009-0069964, filed on Jul. 30, 2009, in the Korean Intellectual Property Office, the disclosure of which is incorporated herein in its entirety by reference.

### BACKGROUND OF THE INVENTION

1. Field of the Invention

The present invention relates to a method and system for online providing information about brand profiling of celebrities and more particularly, to a method and system for providing brand preference of the general public and celebrities as contents and simultaneously using the brand preference in an advertisement.

2. Description of the Related Art

A company that manufactures products creates an advertisement by placing an advertisement order to an advertisement company, and advertises the advertisement via various broadcasting systems, newspapers, Internet, or the like.

In order to create the advertisement, a scenario, a screen frame, or the like are set, actors who appear in the advertisement is cast, and then a moving picture, still images, or the like are photographed under supervision by an advertisement director.

The advertisement director, the advertisement company, or a sponsor selects the actors who will appear in the advertisement.

There may be several references with respect to selection of the actors. In general, celebrities who are popular among the general public are selected. The reason for selecting the popular celebrities as actors for the advertisement is to draw the general public's attention.

However, in a case where the advertisement is created in the aforementioned manner, the advertisement may draw the general public's attention but an effect of the advertisement may be small.

There may be several reasons with respect to the small effect, and one of the reasons is that a product in the advertisement does not match with an image of an actor who appears in the advertisement. That is, the actor may draw the general public's attention, but, if the product in the advertisement does not match with the actor, an image of the product may not be good to the general public such that the advertisement may bring a counter result.

However, it is difficult to find out best match between an actor and a product due to the general public's taste that is rapidly changing, and with respect to time and expenses, it is highly inefficient to survey the best match for every advertisement.

Also, although a brand preference of a preferred actor has a great effect on forming a preference for a corresponding brand, information about brands that are actually used, preferred, or recommended by preferred actors has not been systematically provided, so that there is no way to satisfy the general public's curiosity about the information.

### SUMMARY OF THE INVENTION

The present invention provides a method and system for providing information about brands that are preferred, used, or recommended by celebrities to the general public, and obtaining information about brands that are preferred by other people.

The present invention also provides a method and system for providing information to sponsors, whereby the sponsors may know which celebrities match with their brands and how much their brands are preferred by the general public.

The present invention also provides a computer readable recording medium having recorded thereon a program for executing the method.

According to an aspect of the present invention, there is provided a method of online providing brand profiling information of a celebrity, the method including the operations of having a brand selected for each product category by a plurality of connectors who connect to a website, and having a person selected, wherein the person is approved to match well with the brand; increasing a number indicating how many times the person is selected whenever the person is selected by the plurality of connectors, and when the number exceeds a predetermined reference, changing data indicating whether the person needs to be requested to open his/her brand profiling into an open status, and extracting the person the data of whom is changed to the open status; requesting the person for performing brand profiling; having the person select a brand for the each product category; and opening the brand selected by the person.

According to another aspect of the present invention, there is provided a system for online providing brand profiling information of a celebrity, the system including an input unit having a brand selected for each product category by a plurality of connectors who connect to a website, and having a person selected, wherein the person is approved to match well with the brand; a celebrity extracting unit increasing a number indicating how many times the person is selected whenever the person is selected by the plurality of connectors, and when the number exceeds a predetermined reference, changing data indicating whether the person needs to be requested to open his/her brand profiling into an open status, and extracting the person the data of whom is changed to the open status; and a celebrity brand profiling unit requesting the person for performing brand profiling; having the person select a brand for the each product category; and opening the brand selected by the person.

The celebrity brand profiling unit may allow the brand selected by the person to be open only to general members who have selected their preferring, using, and recommending brands and who are from among the plurality of connectors.

The celebrity extracting unit may extract a person who is selected by most of the plurality of connectors, with respect to each of brands, a corresponding product category, or entire product categories.

The celebrity brand profiling unit may calculate costs according to an operation performed by the person selecting preferring, using, and recommending brands for the each product category, how many times that information regarding the input brands is exposed, and how many times that the information regarding the input brands is clicked, and the costs may correspond to a predetermined ratio of costs that are input from a sponsor of the brands selected by the person.

Information about the person may be open only to a person that satisfies a predetermined condition.

The system may further include a database unit storing information about brands for the each product category and information about a person to be selected for each of the brands.

According to another aspect of the present invention, there is provided a computer readable recording medium having recorded thereon a program for executing the method.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a system according to an embodiment of the present invention; and

FIG. 2 is a flowchart of the method, according to an embodiment of the present invention.

### DETAILED DESCRIPTION OF THE INVENTION

Hereinafter, the present invention will be described in detail by explaining exemplary embodiments of the invention with reference to the attached drawings.

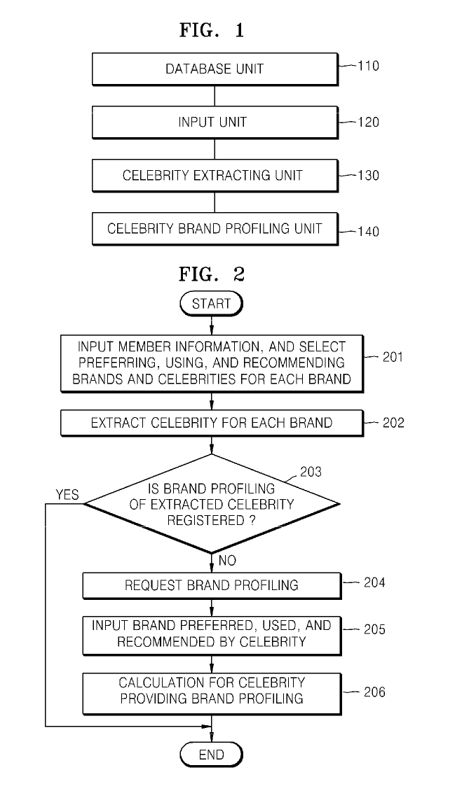

FIG. 1 is a block diagram of a system according to an embodiment of the present invention.

The system according to the present embodiment includes a database unit 110, an input unit 120, a celebrity extracting unit 130, and a celebrity brand profiling unit 140.

One or more embodiments of the present invention are characterized in that which brands' products are preferred, used or recommended by celebrities are open to the general public, and then many people having curiosity about this connect to a result thereof, and select a brand from among categories for each product and select celebrities matching with products of the brand, wherein the brand is preferred, used, and commended by connectors, so that information thereof may be used in an advertisement or the like. Also, a plurality of pieces of data related to brand preference of the general public may provide a communication channel by which individual users may selectively communicate with another person or a group having the similar or same brand preference as them, and in addition, by grouping people according to variables including gender, age, profession, residence or the like, the data may provide information which brand is preferred by each group.

The description about configuring elements of the system will now be provided.

The database unit 110 stores information about products, information about brands for each product category, information about celebrities, and information about members.

The brands for each product category, and the information about celebrities may include names only, or may include detailed description about each of the brands or the products.

Here, the celebrities may indicate people such as entertainers who are well known to the general public via mediums including a television (TV) but are not limited thereto, and thus may indicate general people.

In more detail, the celebrities in the one or more embodiments of the present invention indicate people who may be selected by the connectors as a best match with products of each brand. In a case where a list of the celebrities is determined by a system operator, and selection may be performed only in the list, people in the list indicate the celebrities. However, in a case where the system is set in such a manner that general people may be selected, the celebrities may also indicate the general people.

However, the one or more embodiments of the present invention aim to induce many people to connect to the system, by using the general public's curiosity about products that are actually preferred and used by celebrities who are preferred by the general public, so that the general people may be included in a category of the celebrities but actually, the category of the celebrities only include people who are well known to the general public.

The information about celebrities may only include names, or in a case where the system operator stores connection information, the information about celebrities may include the connection information such as email addresses of the celebrities or companies have the celebrities, telephone numbers or the like.

The information about members includes information that is generally input to connect to a website, and further includes each member's brand profiling information, that is, information about product categories and brand names which are preferred, used, or recommend by each member.

Also, in a case where each member joins the system and then receives a profit according to the system, each member may select where to use the profit, and in this regard, the information about members also includes information thereof.

For example, in a case where the system operator sets the system in such a manner that a part of the profit obtained by operating the system is shared among the members and the shared profit may be donated, each member may set an organization who will receive each member's shared profit.

The input unit 120 may allow connectors to input names of brands and information about persons who match with products of the brands in a desired category only, or may allow connectors to input information in all product categories that are set as an obligation by the system operator.

The input information is stored in the database unit 110.

As described above, the stored information may be used as data so as to inform sponsors of preference for each brand, or may be used to form a communication channel by which individual users may selectively communicate with another person or a group having the similar or same brand preference as them.

In a case where a category of a product and a name of a brand, which are preferred, used, and recommended by each member, and celebrities matching with the brand are selected via the input unit 120, it is recommended to provide a list stored in the database unit 110 and then to receive what is selected from the list. By doing so, it is possible to prevent occurrence of a typo graphical error.

Here, if the list does not include a name of a product category or a brand desired by a member, the member may directly input the name of the brand and transmits it to a site manager and then the site manager registers the brand to a corresponding category in the system, so that the member may select it.

When information about a new product category, a brand, and a celebrity that are not registered in the database unit 110 is input via the input unit 120, the input unit 120 stores the new information in the database unit 110 and informs the system operator of the new information, so that the system manager may check the new information.

When the new information is input, the system operator may check and approve the new information so that the new information may be stored in the database unit 110. However, when the new information is a trick performed by a certain member, or has a typographical error, the system operator may disapprove registration of the new information.

The system operator may add his/her own checked data to the new information, and then register it.

The celebrity extracting unit 130 analyses the information input via the input unit 120, and extracts celebrities selected over references that are set with respect to all brands, a corresponding product category, or each brand.

The references used in extraction of the celebrities may be set by the system operator, and basically, a person who is selected over a predetermined rate or a predetermined number is extracted.

For example, according to a result of selection via the input unit 120, only one person who is approved as a best match with a product of each brand may be extracted, persons who are selected over a predetermined rate in an entire selection result may be extracted, or persons who are selected over a predetermined number may be extracted.

Also, the system operator may choose whether to extract a celebrity based on a selection reference number with respect to each brand, each product category, or all categories.

The database unit 110 has a data field for recording a number indicating how many times a celebrity stored in the database unit 110 is selected by connectors with respect to each brand or all brands, and a data field including data for indicating whether the celebrity needs to be requested to open his/her brand profiling or not.

Whenever a connector selects a celebrity via the input unit 120, the celebrity extracting unit 130 increases a value of the data field for recording the number of selection in the database unit 110. When the number of selection satisfies a predetermined reference, the data of the data field for indicating whether the celebrity needs to be requested to open his/her brand profiling or not is changed from a value for indicating a private status to a value for indicating an open status which means the celebrity needs to be requested to open his/her brand profiling.

The celebrity extracting unit 130 extracts a celebrity whose value of the data for indicating whether the celebrity needs to be requested to open his/her brand profiling or not is the value for indicating an open status, and provides information about the celebrity to the celebrity brand profiling unit 140.

The information about the celebrity extracted by the celebrity extracting unit 130 may be open or not.

Information about brands preferred by the members, and information indicating which celebrity matches well with a certain brand may be highly valuable information to sponsors, advertising companies or the like, so that the information may be open only to companies that pay for it.

In a case where the celebrity brand profiling unit 140 does not store brand profiling information of the celebrity extracted by the celebrity extracting unit 130, that is, when the celebrity has not performed brand profiling yet, the celebrity brand profiling unit 140 transmits information by using connection information stored in the database unit 110, wherein the information indicates that the celebrity is selected over a reference with respect to all brands, a corresponding product category, or each brand, requests the celebrity for brand profiling that is to input information about brands preferred, used, or recommended by the celebrity, and then receives names of the brands preferred by the celebrity that connects to the system.

A person who is selected as the celebrity connects to the system and then performs the brand profiling so that the celebrity inputs information about the brands preferred, used, or recommended by the celebrity.

When the celebrity performs the brand profiling, a separate profit thereof may be provided.

A part of a total profit obtained by operating the system may be provided, or advertisement costs from a sponsor having a brand selected by the celebrity may be partially or completely provided to the celebrity.

The profit provided to the celebrity may be calculated based on how many times the brand preferred, used, and recommended by the celebrity is input, how many times information about the brand is exposed, and how many times a link to the information about the brand is clicked.

The celebrity may register his/her own account number while performing the brand profiling, and when the selected celebrity performs the brand profiling, the celebrity brand profiling unit 140 may allow a particular amount of money calculated in the aforementioned manner to be automatically transferred to the account number.

A result of the brand profiling performed by the celebrity is open to the general public via a website operated by the system according to the present embodiment. Here, the result may be open only to a person who has performed his/her own brand profiling. By doing so, people who want to know the brands preferred, used, and recommended by the celebrities input information about brands preferred, used, and recommended by them.

Hereinafter, a method performed by the system will now be described in detail. FIG. 2 is a flowchart of the method, according to an embodiment of the present invention.

First, a person who wants to know brands selected by celebrities, that is, the person who wants to know which brands are preferred, used, or recommended by the celebrities join a website as a member, wherein the website is operated by the system according to the previous embodiment, and inputs his/her information via the input unit 120. Then, with respect to each product category provided by the input unit 120, the member inputs a brand preferred, used, recommended or selected by the member, and inputs information about a celebrity that matches well with the brand selected by the member. The input information is stored in the database unit 110 (operation 201).

Here, the information of the member includes general personal information about a name, identification (ID), a password, an address or the like, a predetermined profit may be provided with respect to performing brand profiling by using the website, and when expenditure (such as donation) of the profit is set, the information of the member also includes information about a profit usage field involving selection of an organization to receive the profit.

As described above, in a case where a name of a brand preferred by each member, and celebrities matching with the brand are selected via the input unit 120, it is recommended to provide a list stored in the database unit 110 and then to receive what is selected from the list. By doing so, it is possible to prevent occurrence of a typo graphical error. If the list does not include a name of a product category or a brand desired by a member, the member may directly input the name of the brand and transmits it to a site manager and then the site manager registers the brand to a corresponding category in the system, so that members may select it.

For example, when a connecting member having an interest in vehicles wants to register a recommendation brand regarding the vehicles, but a list of brands included in a vehicle category does not include a brand desired by the connecting member, the connecting member directly inputs a name of the brand and transmits it to the site manager. Afterward, the site manager registers the brand to the vehicle category in the system, and then the connecting member may select it.

Also, as described above, when information about a new product category, a brand, and a celebrity that are not registered in the database unit 110 is input via the input unit 120, the input unit 120 stores the new information in the database unit 110 and informs the system operator of the new information, so that the system manager may check the new information.

In selection of a brand for each product category, and a celebrity having an image matching with the brand, only one brand (one celebrity) may be selected or a plurality of brands (a plurality of persons) may be selected according to an order.

A plurality of pieces of Information about brands for each product category, which are selected by connectors via the input unit 120, may be classified into the brands preferred, used, and recommended by them, and may be open to the general public.

Also, it is possible to make groups according to variables including gender, age, profession, residence or the like, to classify the plurality of pieces of Information according to which brands are preferred by people included in each of the groups, and then to provide a result thereof.

As described above, such classified information may be used as data so as to inform sponsors of preference for each brand, and may be used to form a communication channel by which individual users may selectively communicate with another person or a group having the similar or same brand preference as them.

The celebrity extracting unit 130 analyses the information input by members, and extracts celebrities selected over references that are set with respect to all brands, a corresponding product category, or each brand (operation 202).

As described above, whenever a connecting person selects a celebrity via the input unit 120, the celebrity extracting unit 130 increases a value in a data field for recording the number of selection in the database unit 110. When the number of selection satisfies a predetermined reference, data of the data field for indicating whether the celebrity needs to be requested to open his/her brand profiling or not is changed from a value for indicating a private status to a value for indicating an open status which means the celebrity needs to be requested to open his/her brand profiling.

In order to extract celebrities according to a result of selection via the input unit 120, only one person who is approved as a best match with all brands, a corresponding product category, or each brand may be extracted, persons who are selected over a predetermined rate in an entire selection result may be extracted, or persons who are selected over a predetermined number may be extracted. The extracting method may be determined by the system operator using the predetermined rate or the predetermined number.

As described above, the information about the celebrities for each brand extracted by the celebrity extracting unit 130 may be open only to sponsors who pay a predetermined cost.

The information indicating selection of people regarding a best match between a brand and an image of a specific celebrity is highly valuable to the sponsors, and the system according to the previous embodiment may gain a profit by connecting celebrities with the sponsors or advertising companies, based on the information.

The celebrity brand profiling unit 140 determines whether the celebrity that is extracted by the celebrity extracting unit 130 has performed brand profiling (operation 203), if a celebrity that has not performed brand profiling yet is extracted, the celebrity brand profiling unit 140 transmits information by using connection information stored in the database unit 110, wherein the information indicates that the celebrity is selected over a reference with respect to all brands, a corresponding product category, or each brand, requests the celebrity for brand profiling that is to input information about brands preferred, used, or recommended by the celebrity (operation 204), and then receives names of the brands preferred by the celebrity that connects to the system (operation 205).

A celebrity may connect to the website and join as a member after inputting basic person information that is input when general members join the website, and then may input his/her own brand preference, or the celebrity may register to the website in a different manner from the general members and then may input his/her own brand preference.

For example, when the celebrity registers to the website in the different manner, the celebrity brand profiling unit 140 transmits ID information such as a password for identifying the celebrity while the celebrity brand profiling unit 140 requests brand profiling, and then a celebrity ID check procedure may be complete in a manner that the celebrity connects to the website and inputs the password.

The celebrity is already registered in the database unit 110 before the celebrity joins the website as a member, and the celebrity may feel uncomfortable when celebrity's personal information is open, so that the celebrity may be registered in the different manner from the general members.

Also, the celebrity may input an account number so as to receive a profit, or when the celebrity wants the profit to be used in another manner (such as donation) supported by the system operator, the celebrity may input a donation field.

Information about a brand selected by the celebrity, that is, information about the brand profiling is open to the general public via the website operated by the system. Here, the information may be open only to a person who has performed his/her own brand profiling. By doing so, people who want to know the brands preferred, used, and recommended by the celebrities input information about brands preferred, used, and recommended by them.

When the brands selected by the celebrities are open, it is preferred to make a link so as to be connected to a website or an advertisement site of each brand by clicking a name of each brand.

Meanwhile, in a case where the celebrity has a contract by which a predetermined amount of money is paid according to how many times the brand selected by the celebrity is input, how many times information about the brand is exposed, and how many times a link to the information about the brand is clicked, the celebrity brand profiling unit 140 performs calculation therefor (operation 206).

As described above, a share of a profit with respect to the celebrity may be performed in a manner that a part of a total profit obtained by operating the system may be provided, or advertisement costs from a sponsor having the brand selected by the celebrity may be partially or completely provided to the celebrity.

Although not illustrated in drawings, in a case where a profit from the one or more embodiments of the present invention is set to be provided to each member or to be donated to an organization selected by each member, information thereof has to be open after provision or donation is done.

According to the one or more embodiments of the present invention, since there is a high possibility that a celebrity is asked an advertisement contract with respect to a product of a specific brand due to that the celebrity matches with an image of the product of the specific brand, and since the celebrity inputs his/her own preferring, using, or recommending brand and then obtains a profit therefrom, the celebrity may actively participate in the website. With respect to the general public, they may obtain information indicating which brands are preferred by their favourite celebrities, and information about brands preferred by their favourite groups including general people, and they may selectively communicate with people having preference for a specific brand, so that they actively participate in the website.

In addition, sponsors may know which celebrities match well with their brands, and how popular their brands are among the general public. Also, if a celebrity inputs information indicating his/her own preferring brand, this information creates a significant advertisement effect so that the sponsors actively participate in the website. Brand preference information provided from each general member allows the sponsors to deliver the most appropriately customized advertising message to the most appropriate persons, and thus is highly valuable information.

Also, an operator operating the website based on the system may easily activate the website due to active participation of each member and the celebrities, and easily obtain a profit from the sponsors, so that the operator may stably operate the website without a difficulty.

According to the one or more embodiments of the present invention, the general public may be satisfied with their curiosity about brands preferred, used, and recommended by the celebrities, and may obtain information which brands are preferred by other people.

Meanwhile, the celebrities and the system operator may obtain a profit therefrom, and the sponsors may perform a direct advertisement on the general public having different preferences with respect to a specific brand, or may perform an indirect advertisement on the general public by showing them that a specific brand is preferred by a celebrity.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of online providing brand profiling information of a celebrity, the method comprising:
having a brand selected for each product category by a plurality of connectors who connect to a website, and having a person selected, wherein the person is approved to match well with the brand;
increasing a number indicating how many times the person is selected whenever the person is selected by the plurality of connectors, and when the number exceeds a predetermined reference, changing data indicating whether the person needs to be requested to open his/her brand profiling into an open status, and extracting the person the data of whom is changed to the open status;
requesting the person for performing brand profiling;
having the person select a brand for the each product category; and
opening the brand selected by the person.

2. The method of claim 1, wherein the having of the brand selected by the plurality of connectors comprises having a brand selected from among one or more categories classified into a preferring brand, a using brand, and a recommending brand by the plurality of connectors.

3. The method of claim 1, wherein the brand selected by the person is open only to connectors who have performed brand selection and who are from among the plurality of connectors.

4. The method of claim 1, wherein the extracting of the person comprises extracting the person based on the number of selection with respect to each of brands, a corresponding product category, or entire product categories.

5. The method of claim 1, further comprising calculating costs of an operation performed by the person selecting the brand for the each product category,
wherein the costs correspond to a predetermined ratio of costs that are input from a sponsor of the brand selected by the person.

6. The method of claim 1, wherein information about the person is open only to a person that satisfies a predetermined condition.

7. A system for online providing brand profiling information of a celebrity, the system comprising:
an input unit having a brand selected for each product category by a plurality of connectors who connect to a website, and having a person selected, wherein the person is approved to match well with the brand;
a celebrity extracting unit increasing a number indicating how many times the person is selected whenever the person is selected by the plurality of connectors, and when the number exceeds a predetermined reference, changing data indicating whether the person needs to be requested to open his/her brand profiling into an open status, and extracting the person the data of whom is changed to the open status; and
a celebrity brand profiling unit requesting the person for performing brand profiling; having the person select a brand for the each product category; and opening the brand selected by the person.

8. The system of claim 7, wherein the input unit has a brand selected from among one or more categories classified into a preferring brand, a using brand, and a recommending brand by the plurality of connectors.

9. The system of claim 7, wherein the celebrity brand profiling unit allows the brand selected by the person to be open only to connectors who have performed brand selection and who are from among the plurality of connectors.

10. The system of claim 7, wherein the celebrity extracting unit extracts the person based on the number of selection with respect to each of brands, a corresponding product category, or entire product categories.

11. The system of claim 7, wherein the celebrity brand profiling unit calculates costs of an operation performed by the person selecting the brand for the each product category, and
wherein the costs correspond to a predetermined ratio of costs that are input from a sponsor of the brand selected by the person.

12. The system of claim 7, wherein information about the person is open only to a person that satisfies a predetermined condition.

13. The system of claim 7, further comprising a database unit storing information about brands for the each product category and information about a person to be selected for each of the brands.

14. A computer readable recording medium having recorded thereon a program for executing the method of claim 1.
